(19) United States
(12) Patent Application Publication
(10) Pub. No.: US 2008/0313680 A1
(43) Pub. Date: Dec. 18, 2008

(54) Method of Providing an On-Demand Multimedia Service, Service Platform, Program and Decoder for Implementing Said Method

(75) Inventors: Benoit Suzanne, Nanterre (FR); Halim Bendiabdallah, Marnes La coquette (FR)

Correspondence Address: MCKENNA LONG & ALDRIDGE LLP, 1900 K STREET, NW, WASHINGTON, DC, 20006, US

(73) Assignee: France Telecom, 75015, Paris (FR)

(21) Appl. No.: 12/086,699

(22) PCT Filed: Dec. 4, 2006
(86) PCT No.: PCT/FR2006/002642

§ 371 Date: Aug. 12, 2008

(30) Foreign Application Priority Data
Dec. 19, 2005 (FR) 0512891

(51) Int. Cl. H04N 7/173

(52) U.S. Cl. 725/87

(57) ABSTRACT

The multimedia service on request is provided by multimedia data sources (3) each comprising at least one programe flow and an interactivity information file. The programme flow of a source is converted into a transport flow transmitted towards a user terminal by means of a telecommunication network. The service platform collects interaction orders from the user via the telecommunication network, and processes these orders in association with an interactivity information file of the source in order to control the transmitted transport flow.

The present invention relates to the provision of on-demand multimedia services via telecommunication networks. One particular field of application thereof is that of digital television in which one widely-used standard is MPEG2.

The MPEG2 system standard defines two types of multiplexed digital streams: transport streams (TS) and program streams (PS). A “program” is defined as a set of time-correlated basic streams, that is, streams each carrying information to be restored relative to a common time base. A PS stream carries a single program in the form of packets of relatively long and possibly variable length. The program streams (PS) are generally used for storing programs on disk. The transport streams (TS) consist of fixed-length packets belonging to one or more programs, and are used for transmission or broadcasting over networks.

These multiplexed streams TS, PS are constructed from packetized elementary streams (PES). The raw elementary streams (ES) deriving directly from the video or audio encoding are first of all formatted as PES packets of variable length. The PES streams are then segmented to form TS or PS packets to be multiplexed.

The MPEG2 standard is used in several multimedia content distribution systems, notably DVD (Digital Versatile Disk) and DVB (Digital Video Broadcast).

DVD is an optical storage medium disk on which the programs are stored in so-called VOB (Video Object Block) files which correspond to PS stream packets. So-called IFO files are also stored on the disk and contain the information on the chapters, the subtitle tracks and the sound tracks. The IFO files make it possible to offer the user browsing and interactivity elements, notably for choosing languages or subtitles, sometimes for choosing camera angles, for accessing the main menu and the intermediate menus, for fast-forwarding or rewinding in the chapters of the program, and so on.

In a DVD, the multimedia content (VOB), including the sound, the images and the subtitles, is therefore dissociated from the tree structure (IFO) between the various menus. The interactivity of the DVD is based on the display of the video sequence. The IFO files make it possible to select the portions of video to be restored according to actions triggered by the user, normally using his remote control. The succession of the various video portions creates the interactivity through a navigation tree structure. The DVD player has five 16-bit registers for storing any information making it possible to act on the tree structure followed in the IFO file according to prior choices.

DVB is a standard for broadcasting digital television. The streams are broadcast in the TS format, which makes it possible to send several programs in a given bandwidth. The user thus receives a “bouquet” of channels and tables describing information such as channel names, current program names, and so on. These tables enable the user to locally select the channels to be displayed.

DVB is also used to distribute digital television over telecommunication networks, notably of ADSL (Asymmetric Digital Subscriber Line) type. In this application, there is normally provided a TS stream for each channel (SPTS stream, or “Single Program Transport Stream”), the encryption being done at TS level. To display the content, the user's decoder must receive a TS stream.

The video on demand (VOD) services also use the DVB standard. In this application, the telecommunication network supports the Internet protocol (IP), and the TS streams are broadcast in point-to-point mode. Once the transmission of the requested program has begun, the user can have play, pause and fast-forward or rewind functionalities. These functionalities correspond to movements relative to the current position in the transport stream.

On the other hand, the user has no access to functionalities associated with a scene-breakdown of the multimedia content, a choice of the spoken languages or subtitles, a choice of camera angles, and so on, such as those to which he is accustomed when watching a DVD. The interactivity of the VOD services is therefore still very limited.

Today, some VOD offers include, after the transmission of the requested program, the sending of a DVD to the user. The latter can then benefit from the interactivity of the DVD, but not on first viewing of the program. Furthermore, such an offer has the drawback of requiring the content to be sent twice to the user, in two different forms.

One aim of the present invention is to enhance the interactivity of the programs transmitted in an on-demand provision service. More particularly, the desire is to work towards the level of interactivity offered when watching a DVD.

There is thus proposed a method of providing an on-demand multimedia service from multimedia data sources, each comprising at least one program stream and an interactivity information file. According to the invention, the method comprises the following steps:
converting a program stream from at least one source into a transport stream;
transmitting the transport stream to a user terminal via a telecommunication network;
collecting interaction commands from the user via the telecommunication network; and
processing the collected interaction commands in association with the interactivity information files of said source to control the transport stream transmitted via the telecommunication network.

The method makes it possible to emulate multimedia interaction functions of a first type on a transmission architecture of a second type, not designed to support such functions, by remotely processing interaction commands entered by the user.

The multimedia interaction functions of the first type can notably be those offered by a DVD, whereas the architecture of the second type can be that of DVB. These two systems, not compatible with each other, nevertheless share the PESs level of the MPEG2 standard, which makes it possible to convert the program stream into a transport stream using conventional MPEG2 demultiplexers and multiplexers. In this application, the interactivity information files correspond to the IFO files of the DVD, which are interpreted on the VOD service platform in order to offer the user the desired interactivity. Since the encoding level of a DVD is normally greater than that of DVB digital television, another result is a better quality of the restored video and audio content, at the price of greater bandwidth consumption.

The method advantageously makes it possible to remotely operate the interactive content of a film (multi-angle, chapter structure, and so on), the interactive content of a DVD (bonus, games, making of, trailers, and so on), all types of games existing on DVD, all types of educational gaming content existing on DVD and, generally, all types of content exploiting the interactivity offered by the DVD system.

In a first embodiment of the method, the multiplexing operation to construct the transport stream is performed on the fly. The conversion of the program stream into a transport stream then comprises a preliminary storage of multimedia files obtained from the multimedia data source and from interactivity information files of said source and, in response to an interaction command collected and processed in association with a stored interactivity information file, the multiplexing of said multimedia files to form the transport stream transmitted via the telecommunication network.

The multimedia files can notably correspond to PS stream packets. The program stream copying phase is very simple in this embodiment. In the application of the invention to contents available on DVD, the on-the-fly multiplexing of the transport stream makes it possible to interpret the IFO files in the same way as in a standard DVD player.

In another embodiment, the construction of the transport stream is carried out first, the interactivity information files being converted to be adapted to the format of the transport streams. The method then comprises an adaptation of the interactivity information file to the format of the transport stream and a storage of the transport stream and of the adapted interactivity information file, and the processing of the collected interaction commands comprises an interpretation of said commands in relation to the interactivity information file to control the reading and the transmission of the stored transport stream.

This embodiment reduces the complexity of the service platform because it eliminates the real-time remultiplexing operation which requires significant computation capability.

Another aspect of the invention relates to a service platform for the provision of an on-demand multimedia service from multimedia data sources, each comprising at least one program stream and an interactivity information file. This platform comprises: means of converting a program stream from at least one source into a transport stream; means of transmitting the transport stream to a user terminal via a telecommunication network; means of receiving interaction commands from the user via the telecommunication network; and means of processing collected interaction commands in relation to an interactivity information file of said source to control the transport stream transmitted via the telecommunication network.

Yet another aspect of the invention relates to a computer program for installation in a service platform for the provision of an on-demand multimedia service from multimedia data sources, each comprising at least one program stream and an interactivity information file. The program comprises instructions for controlling the following steps when the program is executed by a processing unit of the platform:
transmitting to a user terminal, via a telecommunication network, a transport stream obtained by conversion of a program stream from at least one source;
collecting interaction commands from the user via the telecommunication network; and
processing the collected interaction commands in relation to an interactivity information file from said source to control the transport stream transmitted via the telecommunication network.

The invention also relates to a digital television decoder, comprising:
a communication interface with a platform for supplying on-demand multimedia services via a telecommunication network;
means for receiving a transport stream representing a program requested by a user, comprising interactive menus, decoding the transport stream and restoring the requested program; and
means for receiving interaction commands from the user in relation to said interactive menus and transmitting messages reflecting said commands to the platform via the telecommunication network.

The invention also relates to a method of processing multimedia data in a digital television decoder, comprising the following steps:
receiving, from a platform for supplying on-demand multimedia services, via a telecommunication network, a transport stream representing a program requested by a user, comprising interactive menus;
decoding the transport stream and restoring the requested program;
receiving interaction commands from the user in relation to said interactive menus;
transmitting, via the telecommunication network, messages reflecting said commands, said messages being suitable for processing by the platform in relation to the interactivity information file associated with the program to control the transport stream transmitted via the telecommunication network.

Another aspect of the invention relates to a computer program for installation in a digital television decoder, comprising instructions for controlling the following steps when the program is executed by a processing unit of the platform:
receiving, from a platform for providing on-demand multimedia services, via a telecommunication network, a transport stream representing a program requested by a user, comprising interactive menus;
decoding the transport stream and restoring the requested program;
receiving interaction commands from the user in relation to said interactive menus;
transmitting, via the telecommunication network, messages reflecting said commands, said messages being suitable for processing by the platform in relation to an interactivity information file associated with the program to control the transport stream transmitted via the telecommunication network.

Other features and advantages of the present invention will become apparent from the following description of non-limiting exemplary embodiments, with reference to the appended drawings, in which:

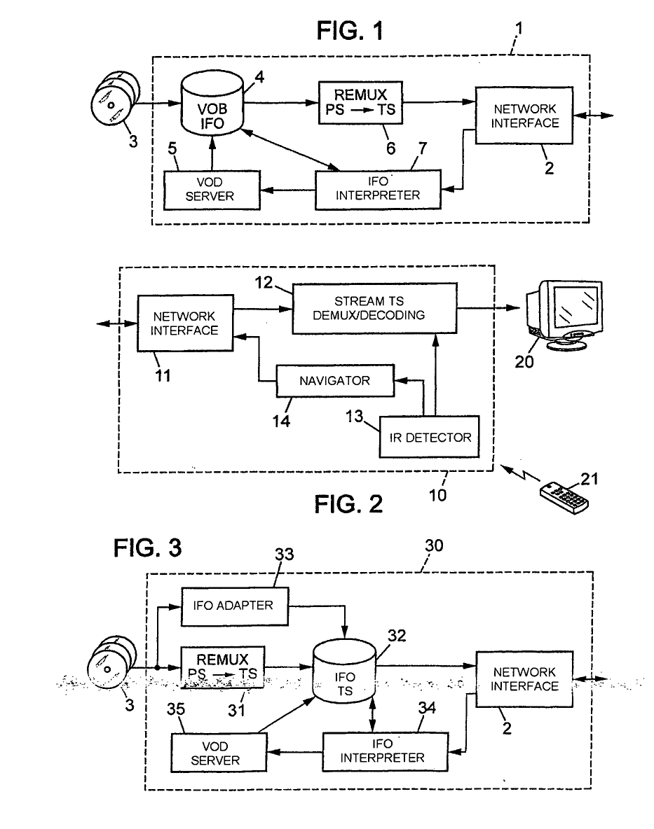

FIG. 1 is a block diagram of an exemplary VOD service platform according to the invention;

FIG. 2 is a simplified block diagram of an exemplary digital television decoder according to the invention; and

FIG. 3 is a block diagram of another exemplary VOD service platform according to the invention.

Referring to FIG. 1, a service platform 1 comprises a network interface 2 for communicating with user terminals. The telecommunication network employed is, for example, an IP-over-ADSL network.

The inventive service platform exploits interactive contents available on DVD or similar-type storage media 3. In the embodiment illustrated by FIG. 1, a preliminary step of the method consists in saving the contents of the DVDs 3 in a database 4 of the platform, stored on hard disks. For each DVD disk, the database 4 stores all of the VOB files, which contain PS stream packets, and corresponding interactivity information files (IFO).

The platform 1 also comprises a video-on-demand (VOD) server 5. Conventionally, the server 5 is adapted to present to the users a video interface enabling them to select the requested contents and perform the corresponding transactions. The server 5 manages the VOD sessions of the various users and controls the reading of the audio and video files corresponding to the contents requested by the users. In the present case, these files are saved in the database 4 in the PS format, and the VOD server 5 must therefore be able to perform the addressing of the stream in the PS format.

The PS stream for which reading is controlled by the server 5 is submitted to an MPEG2 remultiplexer 6 which converts it into a single-program TS stream (SPTS) suitable for DVB transmission. The MPEG2 remultiplexing operation is conventional. The PES packets are extracted from the PS stream with the corresponding time markers, then the latter are used to multiplex the PES packets in a TS stream.

The duly constructed TS stream is transmitted to the relevant user via the interface 2 and the telecommunication network.

FIG. 2 diagrammatically shows the DVB decoder 10 with which a user is equipped. Its network interface 11 recovers the received TS stream, and supplies it to the MPEG2 demultiplexing and decoding module 12. This module 12 restores the audio and video signals which are supplied to the user's television 20. In the context of the present invention, the demultiplexing and decoding module 12 can be standard.

The user interface typically comprises an infrared remote control 21 which, depending on the actions of the user, sends different signals picked up by an infrared detector 13 of the decoder 10.

The decoder 10 comprises a communication software layer 14, generally based on an HTML (HyperText Markup Language) browser-type application. The browser 14 is notified of certain user control signals picked up by the detector 13. Such signals relate, for example, to pause/play or fast-forward/rewind commands, that the browser 14 translates into HTML requests transmitted via the interface 11 and the telecommunication network according to the HTTP protocol (HyperText Transfer Protocol). These requests are interpreted on the VOD server 5 and give rise to corresponding modifications to the reading of the multimedia stream in the database 4.

According to the invention, the user commands that the browser 14 of the decoder 10 reflects in HTML requests transmitted over the network also include interaction commands which are related to the interactivity information encountered in the DVDs. Thus, commands such as for changing chapter or commands that can be selected from DVD menus displayed on the screen give rise to the transmission of specific HTML requests which will be interpreted by a module 7 added to the VOD server in the service platform 1. The user thus has the possibility of browsing through the tree structure of the menus of the DVD that he is currently viewing.

The interpreter module 7 analyzes the interaction commands received in the HTML requests in relation to the IFO file, stored in the database 4, which corresponds to the video sequence currently being transmitted. The IFO interpreter 7 is similar to that usually encountered in DVD players. For each DVD session in progress for a user, it in particular allocates a memory area for emulating the five 16-bit registers storing the information that makes it possible to act on the tree structure followed in the IFO file according to prior choices.

Thus, each user command can be interpreted to control the addressing of the stream currently being read according to the chapter structure of the DVD, to select audio or subtitle files corresponding to languages chosen by the user, to select video portions corresponding to camera angles chosen by the user, and so on.

Depending on the result of the interpretation of the commands, the VOD server 5 controls the reading in memory of the PS stream to be supplied to the remultiplexer 6.

FIG. 3 illustrates another possible architecture of the inventive VOD service platform. In this platform 30, the remultiplexing of the PS stream, read on a DVD 3, into a TS stream is performed not in real time during a VOD session but in the preliminary phase for saving the content of the disk 3. There is therefore a reduced speed constraint on the MPEG2 remultiplexer 31.

The multimedia streams are therefore saved in the TS format in the database 32 of the platform 30. The addressing of the stream used in the IFO files of the DVD must be modified in order to take account of the rearrangement of the stream. This modification is done by an adaptation module 33 in parallel with the remultiplexing operation. The adapted IFO files are saved in the database 32 in relation to the corresponding sequences of the TS stream.

The IFO interpreter 34 of the platform 30 then uses the adapted IFO files in order to address to the VOD server 35 the addressing parameters of the stored TS stream. In this embodiment, the VOD server 35 can be of conventional type to control the reading in memory of TS streams.

The embodiment of FIG. 3 has the advantages of making it possible to use a market-standard VOD server and avoid the real-time remultiplexing operation, which is relatively costly in terms of computation capacity.

In practice, in one or other of the embodiments described, the invention can be implemented by means of computer programs executed by one or more processors of the service platform 1, 30 and designed to complement the functionalities of the VOD server 5, 35 in terms of interpretation of the IFO files and of remultiplexing.

The invention has been described hereinabove in the context of the DVD and DVB standards. Naturally, it is not limited to these standards. The invention is notably applicable to all types of interactive content storage media (HD-DVD, Blu Ray, and so on).

Also, the user equipment can take widely differing forms. For example, the decoder 10 can be part of a terminal, which can, for example, be a microcomputer, whose screen and sound card are used to restore the multimedia content and whose user interface (keyboard, mouse, etc.) is used to enter interaction commands. The terminal can, in another embodiment, be a television, a set-top-box or even a mobile terminal such as a telephone.

1. A method of providing an on-demand multimedia service from multimedia data sources each comprising at least one program stream and an interactivity information file, the method comprising the steps of:
converting a program stream from at least one source into a transport stream;
transmitting the transport stream to a user terminal via a telecommunication network;
collecting interaction commands from the user via the telecommunication network; and
processing the collected interaction commands in association with an interactivity information file of said source to control the transport stream transmitted via the telecommunication network.

2. The method as claimed in claim 1, wherein the conversion of the program stream into a transport stream comprises:
storing preliminary multimedia files obtained from the multimedia data source and from interactivity information files of said source; and
in response to an interaction command collected and processed in association with a stored interactivity information file, multiplexing said multimedia files to form the transport stream transmitted via the telecommunication network.

3. The method as claimed in claim 1, further comprising the steps of:
adapting the interactivity information file to a format of the transport stream; and
storing the transport stream and the adapted interactivity information file,
wherein the processing of the collected interaction commands comprises interpreting said commands in relation to the interactivity information file to control reading and transmission of the stored transport stream.

4. The method as claimed in claim 1, wherein the multimedia data sources comprise optical storage media.

5. A service platform for providing an on-demand multimedia service from multimedia data sources each comprising at least one program stream and an interactivity information file, the platform comprising:
a converter for converting a program stream from at least one source into a transport stream;
a transmitter for transmitting the transport stream to a user terminal via a telecommunication network;
a receiver for receiving interaction commands from the user via the telecommunication network; and
a processor for processing collected interaction commands in relation to an interactivity information file of said source to control the transport stream transmitted via the telecommunication network.

6. The service platform as claimed in claim 5, wherein said converter for converting the program stream into a transport stream comprises a preliminary storage unit for multimedia files obtained from the multimedia data source and from interactivity information files of said source, and a multiplexer for multiplexing said multimedia files in response to an interaction command collected and processed in relation to a stored interactivity information file to form the transport stream transmitted via the telecommunication network.

7. The service platform as claimed in claim 5, further comprising an adapter for adapting the interactivity information file to a format of the transport stream and memory for storing the transport stream and the adapted interactivity information file, wherein the processor for processing the collected interaction commands comprises an interpreter for interpreting said commands in relation to the interactivity information file to control the reading of the stored transport stream and supply the transmitter.

8. A computer program for installation in a service platform for providing an on-demand multimedia service from multimedia data sources each comprising at least one program stream and an interactivity information file, the program comprising instructions for controlling the following steps when the program is executed by a processing unit of the platform:
transmitting to a user terminal via a telecommunication network, a transport stream obtained by conversion of a program stream from at least one source;
collecting interaction commands from the user via the telecommunication network; and
processing the collected interaction commands in relation to an interactivity information file of said source to control the transport stream transmitted via the telecommunication network.

9. The program as claimed in claim 8, wherein multimedia files obtained from the multimedia data source and from the interactivity information files of said source are previously stored, the program also comprising instructions for multiplexing the stored multimedia files to form the transport stream transmitted via the telecommunication network.

10. The program as claimed in claim 8, wherein the interactivity information file is adapted to a format of the transport stream and the transport stream and the adapted interactivity information file are stored preliminarily, the processing of the collected interaction commands comprising interpreting said commands in relation to the interactivity information file to control reading and transmission of the stored transport stream.

11. A digital television decoder comprising:
a interface for communicating with a platform for supplying on-demand multimedia services via a telecommunication network;
a receiver for receiving a transport stream representing a program requested by a user, comprising interactive menus, decoding the transport stream and restoring the requested program; and
a receiver for receiving interaction commands from the user in relation to said interactive menus and transmitting messages reflecting said commands to the platform via the telecommunication network.

12. A method of processing multimedia data in a digital television decoder comprising the steps of:
receiving, from a platform for supplying on-demand multimedia services via a telecommunication network, a transport stream representing a program requested by a user, comprising interactive menus;
decoding the transport stream and restoring the requested program;
receiving interaction commands from the user in relation to said interactive menus;
transmitting, via the telecommunication network, messages reflecting said commands, said messages being suitable for processing by the platform in relation to an interactivity information file associated with the program to control the transport stream transmitted via the telecommunication network.

13. A computer program for installation in a digital television decoder comprising instructions for controlling the following steps when the program is executed by a processing unit of the platform:
receiving, from a platform for providing on-demand multimedia services via a telecommunication network, a transport stream representing a program requested by a user, comprising interactive menus;
decoding the transport stream and restoring the requested program;
receiving interaction commands from the user in relation to said interactive menus;
transmitting, via the telecommunication network, messages reflecting said commands, said messages being suitable for processing by the platform in relation to an interactivity information file associated with the program to control the transport stream transmitted via the telecommunication network.
